(19) United States
(12) Patent Application Publication
(10) Pub. No.: US 2006/0170972 A1
(43) Pub. Date: Aug. 3, 2006

(54) System and method of processing an error diffusion halftone image

(75) Inventor: Chih-Chieh Lin, Taipei City (TW)

Correspondence Address: BACON & THOMAS, PLLC, 625 SLATERS LANE, FOURTH FLOOR, ALEXANDRIA, VA, 22314, US

(73) Assignee: Sunplus Technology CO., Ltd., Hsinchu (TW)

(21) Appl. No.: 11/229,512

(22) Filed: Sep. 20, 2005

(30) Foreign Application Priority Data
Feb. 1, 2005 (TW) 094102986

(51) Int. Cl. H04N 1/40

(52) U.S. Cl. 358/3.03

(57) ABSTRACT

A system and method of processing an error diffusion half-tone image, which produces a halftone image in accordance with a continuous-tone image. The continuous tone image consists of a two-dimension array of pixels (i, j), where i, j indicate i-th row and j-th column of the image. The method includes: (A) selecting a threshold as a k-th color threshold in accordance with a value of a k-th color of a pixel (i, j); (B) comparing the value of the k-th color of the pixel (i, j) and the k-th color threshold; (C) outputting a bi-level value associated with the k-th color of the pixel (i, j) in accordance with a comparison result produced in step (B); (D) determining an error between the k-th color value of the pixel (i, j) and the bi-level value; (E) diffusing the error to k-th colors of pixels adjacent to the pixel (i, j).

### BACKGROUND OF THE INVENTION

1. Field of the Invention

The invention relates to the technical field of halftone image processing and, more particularly, to a system and method of processing an error diffusion halftone image.

2. Description of Related Art

In a practical print technology used in a printer, due to a low resolution on human eyes, when a group of dots is densely arranged on a small area, the human eyes cannot distinguish one dot from another but feel an averaged reflectivity formed by the dots. Thus, different gray levels in printing are produced by controlling the density of the dots. A typical halftone technique can determine individual positions of the dots to accordingly obtain a desired gray level and reduce an uncomfortable effect in a frame on the eyes.

The halftone image technique is typically used in binary image output devices such as inkjet printers, laser printers, and the like. Such output devices present an image proximate to an original continuous-tone by determining each pixel to be printed or not. Thus, great information may be lost in the halftone processing, and it causes some defects, such as fixed frequency patterns, worm patterns and the like, that are easily viewed by the eyes.

A typical technique in the halftone image processing is an error diffusion. FIGS. 1A to 1D are schematic view of an operation of the error diffusion, which essentially has three steps. First, a continuous-tone data is input to compare with a threshold, as shown in FIG. 1A in which a color value (80) of a pixel (i,j) is compared with a threshold (127). Because the color value (80) is smaller than the threshold (127), the color value (80) of the pixel (i,j) is reset to zero to output. In FIG. 1B, an error (80) of the output (0) and the value (80) is calculated. In FIGS. 1C and 1D, the error (80) is proportionally diffused to adjacent pixels in accordance with an error diffusion matrix 110. The cited steps are repeated until the entire image is complete. The error diffusion can relatively improve the output quality of an image but cannot completely eliminate the defects of all output images.

U.S. Pat. No. 5,737,453 discloses a threshold mask to averagely diffuse the dots, and an error diffusion matrix changed with the positions of input pixels. Such an error diffusion matrix can improve image defects on light and dark regions but easily produce fixed frequency patterns in a median tone image.

Therefore, it is desirable to provide an improved system and method to mitigate and/or obviate the aforementioned problems.

### SUMMARY OF THE INVENTION

The object of the invention is to provide a system and method of processing an error diffusion halftone image, which can avoid the problem of fixed frequency patterns or worm patterns produced in the prior art and further reduce the uncomfortable effect in a frame for human eyes.

In accordance with one aspect of the present invention, there is provided a system of processing an error diffusion halftone image. The system produces a halftone image in accordance with a continuous-tone image. The continuous-tone image consists of a two-dimension (2D) array of pixels (i, j), where i, j are a positive integer and indicate i-th row and j-th column of the image. The system includes an adder, a threshold generator, a comparator, a subtractor and an error diffuser. The adder has a first input terminal to receive a color of a pixel (i, j) and a second input terminal to receive a feedback color error diffusion signal, thereby producing a corrected color of the pixel (i, j). The threshold generator has a first input terminal to receive a position of the pixel (i, j) and a second input terminal to receive the color of the pixel (i, j), and selects a color threshold in accordance with the position of the pixel (i, j) and a value of the color of the pixel (i, j). The comparator is connected to the adder and the threshold generator in order to compare a value of the corrected color and the color threshold and thus produces a bi-level value associated with the color of the pixel (i, j). The subtractor has a first input terminal to receive the corrected color and a second input terminal to receive the bi-level value, and subtracts the value of the corrected color from the bi-level value to thus produce a color error. The error diffuser is connected to the subtractor in order to produce the feedback of the color error diffusion signal.

In accordance with another aspect of the present invention, there is provided a method of processing an error diffusion half-tone image. The method produces a halftone image in accordance with a continuous-tone image. The continuous-tone image consists of a 2D array of pixels (i, j), where i, j are a positive integer and indicate i-th row and j-th column of the image. The method includes: (A) selecting a threshold as a color threshold in accordance with a value of a color of a pixel (i, j); (B) comparing the value of the color of the pixel (i, j) and the color threshold; (C) generating a bi-level value associated with the color of the pixel (i, j) in accordance with a comparison result produced in step (B); (D) determining an error between the value of the color of the pixel (i, j) and the bi-level value; (E) diffusing the error to colors of pixels adjacent to the pixel (i, j).

Other objects, advantages, and novel features of the invention will become more apparent from the following detailed description when taken in conjunction with the accompanying drawings.

### BRIEF DESCRIPTION OF THE DRAWINGS

FIGS. 1A to 1D are schematic views of an operation of typical error diffusion;

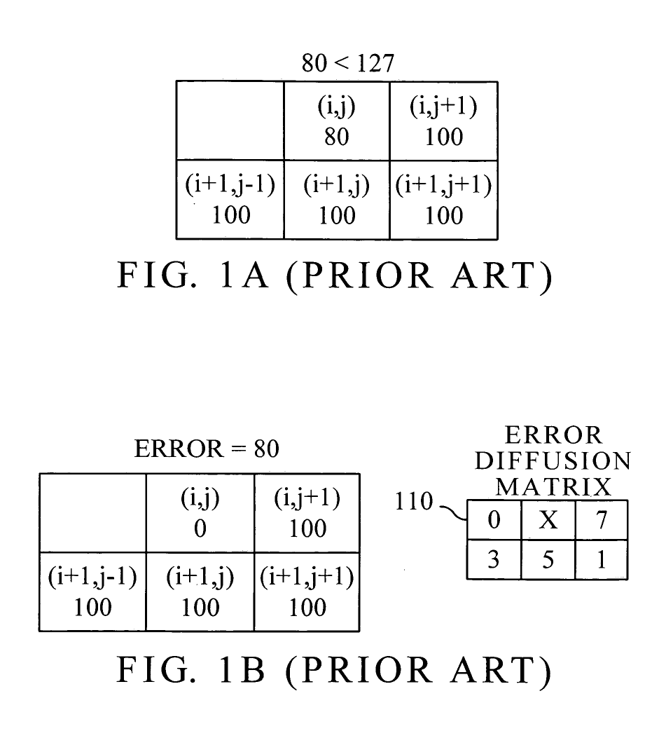

FIG. 2 is a block diagram of a system of processing an error diffusion halftone image in accordance with the invention;

FIG. 3 is a schematic view of a threshold table in accordance with the invention;

FIG. 4 is a flowchart of a method of processing an error diffusion halftone image in accordance with the invention;

FIG. 5A is a schematic view of typically processing a median tone image; and

FIG. 5B is a schematic view of processing a median tone image in accordance with the invention.

### DETAILED DESCRIPTION OF THE PREFERRED EMBODIMENT

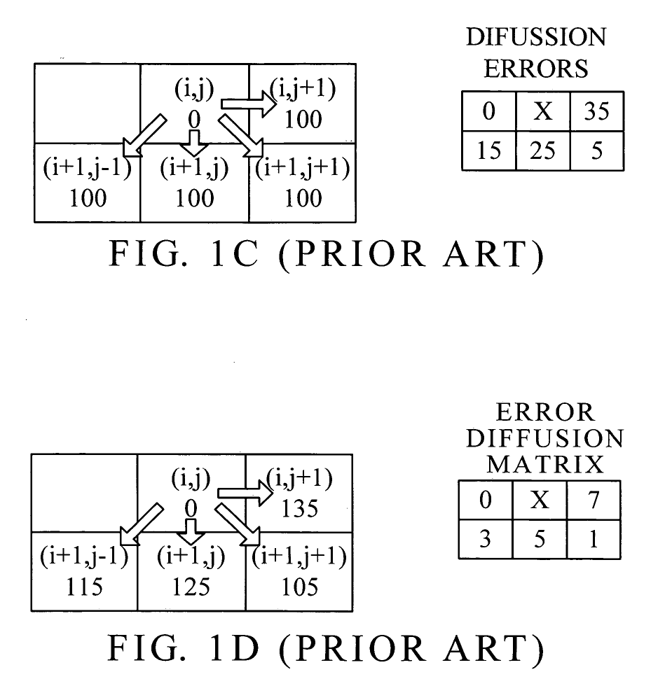

FIG. 2 is a block diagram of a system of processing an error diffusion halftone image in accordance with the invention. The system processes a continuous-tone image and produces a halftone image. The continuous-tone image consists of a two-dimension (2d) array of pixels (i, j), where i, j are a positive integer and indicate i-th row and j-th column of the image. Each pixel (i, j) contains three colors of cyan, magenta and yellow, and values of which are respectively denoted as C(i,j), M(i,j) and Y(i,j). The system includes an adder 210, a threshold generator 220, a comparator 230, a subtractor 240 and an error diffuser 250.

The adder 210 has a first input terminal to receive a color of a pixel (i, j). In this case, the C(i,j) is given as an example, and is also similar to the magenta and the yellow. The adder 210 also has a second input terminal to receive a feedback error diffusion signal of the color, thereby producing a corrected value C(i,j )′ of the cyan of the pixel (i, j).

The threshold generator 220 has a first input terminal 221 to receive a position of the pixel (i, j) and a second input terminal 222 to receive the C(i, j) of the pixel (i, j), and selects a cyan threshold in accordance with the position and C(i,j ) of the pixel (i, j).

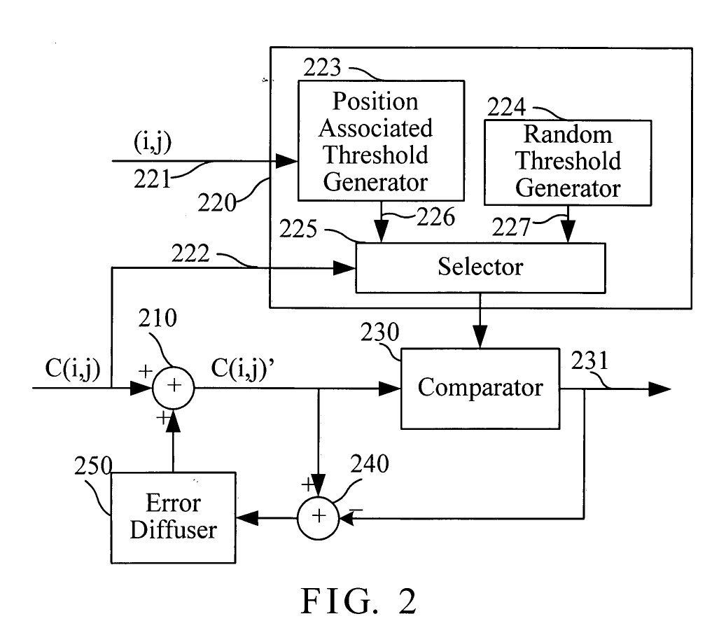

The threshold generator 220 includes a position associated threshold generator 223, a random threshold generator 224 and a selector 225. The position associated threshold generator 223 produces a position associated threshold in accordance with the position of the pixel (i, j). FIG. 3 is a threshold table 310. When the pixel (i, j) locates on position (2, 3), namely i=2 and j=3, the position associated threshold generator 223 selects a threshold (49) at second row and third column of the threshold table 310 as the position associated threshold 226. Namely, the position associated threshold generator 223 selects a threshold based on x row and y column of the threshold table 310, wherein x=(i mod 8) and y=(j mod 8).

The random threshold generator 224 uses a random function generator to directly generate a random threshold 227, where the random threshold 227 ranges from 0 to 255.

The selector 225 is connected to the position associated threshold generator 223 and the random threshold generator 224, and selects the position associated threshold 226 or random threshold 227 as the cyan threshold in accordance with the C(i, j) of the pixel (i, j). When the C(i, j) of the pixel (i, j) is a median tone, the selector 225 selects the random threshold 227 as the cyan threshold, wherein the median tone ranges from 70 to 140. Namely, the selector 225 selects the random threshold 227 as the cyan threshold when 70≦C(i,j)≦140, and otherwise the position associated threshold 226 is selected as the cyan threshold.

The comparator 230 is connected to the adder 210 and the threshold generator 220. The comparator 230 compares the corrected value C(i,j)′ and the cyan threshold to thus produce a bi-level value 231 for the cyan of the pixel (i,j). When the corrected value C(i,j)′ exceeds the cyan threshold, a first bi-level value (255) is produced for the cyan of the pixel (i, j), and a halftone output signal (not shown) is set to be open. Conversely, when the corrected value C(i,j)′ does not exceed the cyan threshold, a second bi-level value (0) is produced for the cyan of the pixel (i, j ), and the halftone output signal (not shown) is set to be closed. When the inventive technology is applied to a color printer, a value of the halftone output signal can indicate whether or not the pixel (i,j) is printed.

The subtractor 240 has a first input terminal to receive the corrected value C(i,j)′ and a second input terminal to receive the bi-level value associated with the cyan of the pixel (i, j). The subtractor 240 subtracts the corrected value C(i,j)′ from the bi-level value to thus produce a cyan error. The error diffuser 250 is connected to the subtractor 240 in order to produce a feedback cyan error diffusion signal in accordance with an error diffusion matrix (not shown) and the cyan error.

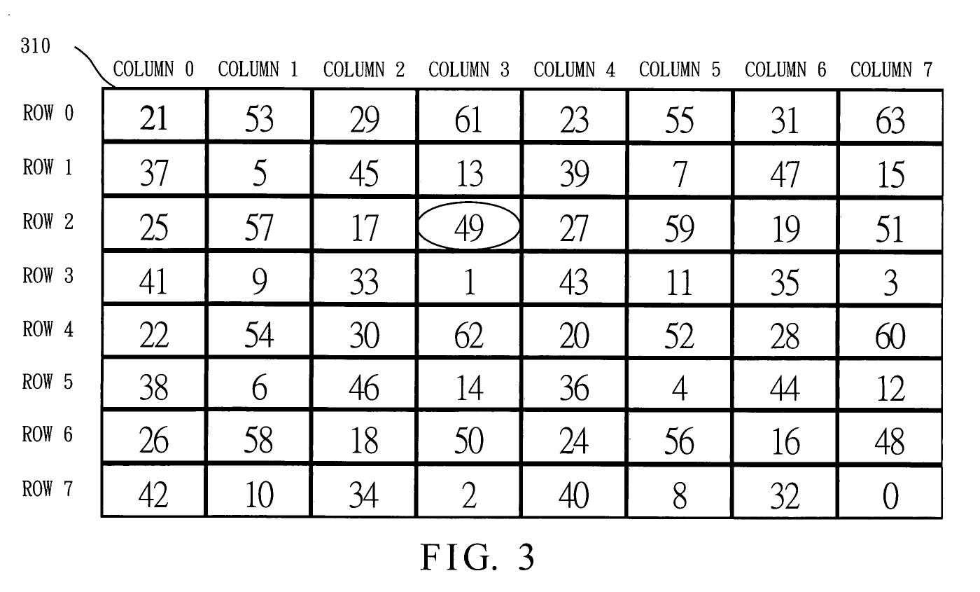

FIG. 4 is a flowchart of a method of processing an error diffusion halftone image in accordance with the invention. The method produces a halftone image in accordance with a continuous-tone image. The continuous-tone image consists of a 2D array of pixels (i, j), where i, j are a positive integer and indicate i-th row and j-th column of the image. Each pixel (i, j) contains three colors of cyan, magenta and yellow, and values of which are denoted as C(i, j), M (i, j) and Y(i, j) respectively. In this case, the C(i, j) is given as an example, and is also similar to the magenta and the yellow.

In step S405, a continuous-tone data is received, i.e., the C(i,j), associated with a pixel (i,j). Step S410 determines if the C(i,j ) belongs to a light or deep color section, i.e., the C(i,j) is smaller than 70 or greater than 140. If the C(i,j) belongs to a light or deep color section, step S415 is executed; otherwise, step S420 is executed.

In step S415, it is based on the pixel position (i, j) associated with the pixel currently processing to accordingly obtain a respective threshold, i.e., the respective threshold Th is a function of the pixel position (i, j) (Th=F(i, j)). Step S420 uses a random generator to generate a threshold, i.e., the respective threshold Th is equal to random function(Th=random function). Step S425 determines if the C(i, j) is greater than the threshold Th; if yes, step S430 is executed, and if not, step S435 is executed.

In step S430, a first bi-level value (255) associated with the cyan of the pixel (i, j) is output and also a halftone output signal (not shown) is set to be open. In step S435, a second bi-level value (0) associated with the cyan of the pixel (i,j) is output, and also the halftone output signal is set to be closed. When the inventive technology is applied to a color printer, a value of the halftone output signal can indicate whether or not the pixel (i,j) is printed.

Step S440 calculates a cyan error by subtracting the C(i,j) from the bi-level value associated with the pixel (i,j). Step S445 diffuses the cyan error to adjacent pixels in accordance with a diffusion matrix. Step S450 repeats the entire procedure until the whole image is complete.

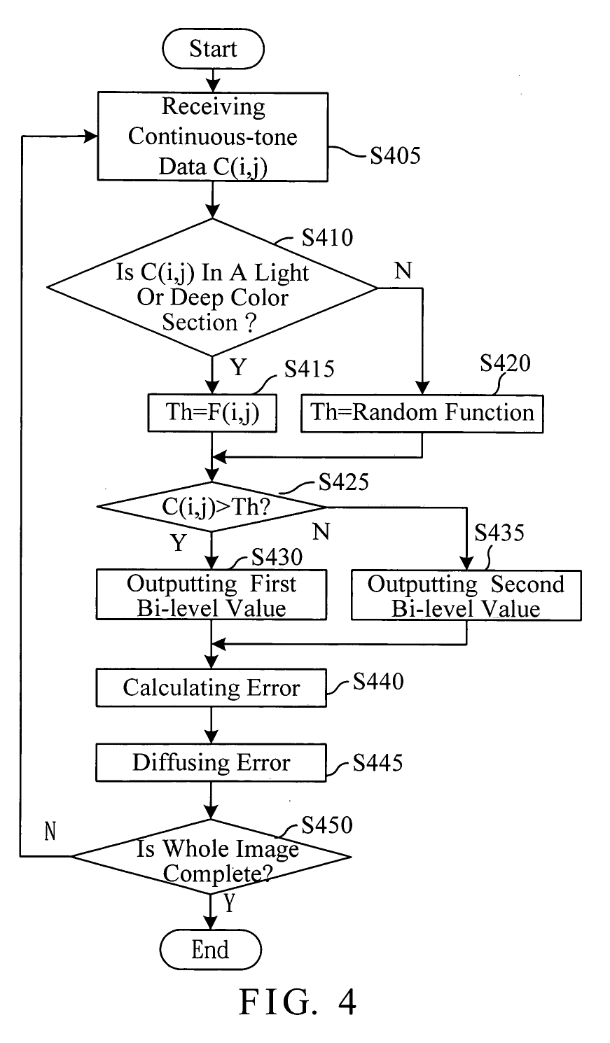

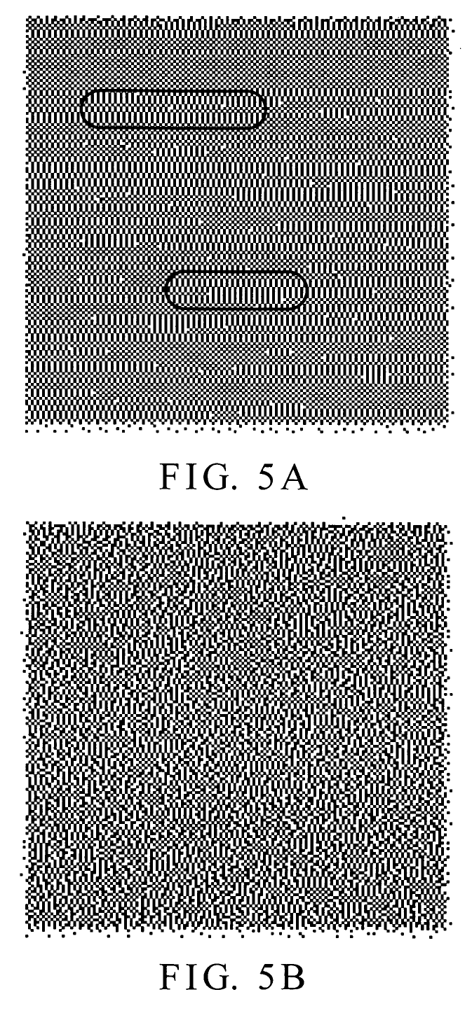

FIG. 5A is a schematic view of typically processing a median tone image. As shown in FIG. 5A, the median region produces fixed frequency patterns due to the over-regularity. However, FIG. 5B shows a schematic view of processing a median tone image in accordance with the invention, which does not have such fixed frequency patterns. This is because the inventive threshold generator 220 can select the position associated threshold 226 or random threshold 227 as the cyan threshold in accordance with the C(i,j) of the pixel (i,j), and selects the random threshold 227 produced by the random function when processing a median tone image, thereby avoiding the prior fixed frequency patterns.

As cited, the inventive system and method of processing an error diffusion halftone image use the threshold produced by the random function in processing the median tone image, which can avoid the fixed frequency patterns produced by the over-regularity and further reduce an uncomfortable effect in a frame on human eyes.

Although the present invention has been explained in relation to its preferred embodiment, it is to be understood that many other possible modifications and variations can be made without departing from the spirit and scope of the invention as hereinafter claimed.

What is claimed is:

1. A system of processing an error diffusion halftone image, which produces a halftone image in accordance with a continuous-tone image consisting of a two-dimension (2D) array of pixels (i, j), where i, j are a positive integer and indicate i-th row and j-th column of the image, the system comprising:
an adder, which has a first input terminal to receive a color of a pixel (i, j), and a second input terminal to receive a feedback color error diffusion signal, thereby producing a corrected color of the pixel (i, j);
a threshold generator, which has a first input terminal to receive a position of the pixel (i, j) and a second input terminal to receive the color of the pixel (i, j), and selects a color threshold in accordance with the position of the pixel (i, j) and a value of the color of the pixel (i, j);
a comparator, which is connected to the adder and the threshold generator in order to compare a value of the corrected color and the color threshold and thus produces a bi-level value associated with the color of the pixel (i, j);
a subtractor, which has a first input terminal to receive the corrected color and a second input terminal to receive the bi-level value, and subtracts the value of the corrected color from the bi-level value to thus produce a color error; and
an error diffuser, which is connected to the subtractor in order to produce the feedback color error diffusion signal.

2. The system as claimed in claim 1, wherein the threshold generator comprises:
a position associated threshold generator, which produces a position associated threshold in accordance with the position of the pixel (i, j);
a random threshold generator, which randomly produces a random threshold; and
a selector, which is connected to the position associated threshold generator and the random threshold generator and selects the position associated threshold or the random threshold as the k-th color threshold in accordance with the value of the color of the pixel (i, j).

3. The system as claimed in claim 2, wherein when the value of the color of the pixel (i, j) ranges in a median tone region, the selector selects the random threshold as the color threshold.

4. The system as claimed in claim 1, wherein when the value of the corrected color of the pixel (i, j) exceeds the color threshold, a first bi-level value associated with the color of the pixel (i, j) is produced, and when the value of the corrected color of the pixel (i, j) does not exceed the color threshold, a second bi-level value associated with the color of the pixel (i, j) is produced.

5. The system as claimed in claim 4, wherein the first bi-level value is 255.

6. The system as claimed in claim 4, wherein the second bi-level value is zero.

7. The system as claimed in claim 1, wherein the color of the pixel (i,j) can be cyan, magenta or yellow.

8. A method of processing an error diffusion halftone image, which produces a halftone image in accordance with a continuous-tone image consisting of a two-dimension (2D) array of pixels (i, j), where i, j are a positive integer and indicate i-th row and j-th column of the image, the method comprising the steps:
(A) selecting a threshold as a color threshold in accordance with a value of a color of a pixel (i, j);
(B) comparing the value of the color of the pixel (i, j) and the color threshold;
(C) generating a bi-level value associated with the color of the pixel (i, j) in accordance with a comparison result produced in step (B);
(D) determining an error between the value of the color of the pixel (i, j) and the bi-level value; and
(E) diffusing the error to colors of pixels adjacent to the pixel (i, j).

9. The method as claimed in claim 8, wherein the step (A) further comprises:
(A1) generating a position associated threshold in accordance with a position of the pixel (i, j);
(A2) randomly producing a random threshold; and
(A3) selecting the position associated threshold or the random threshold as the color threshold based on the value of the color of the pixel (i, j).

10. The method as claimed in claim 9, wherein when the value of the color of the pixel (i, j) is in a median tone region, the random threshold is selected as the color threshold.

11. The method as claimed in claim 8, wherein when the value of the corrected color of the pixel (i, j) exceeds the color threshold, a first bi-level value associated with the color of the pixel (i, j) is produced, and when the value of the corrected color of the pixel (i, j) does not exceed the color threshold, a second bi-level value associated with the color of the pixel (i, j) is produced.

12. The method as claimed in claim 11, wherein the first bi-level value is 255.

13. The method as claimed in claim 11, wherein the second bi-level value is zero.

14. The method as claimed in claim 8, wherein the color of the pixel (i,j) can be cyan, magenta or yellow.

15. The method as claimed in claim 8, wherein the pixels adjacent to the pixel (i, j) are pixels (i,j+1), (i+1,j−1), (i+1,j), (i+1,j+1).
